(19) United States
(12) Patent Application Publication
(10) Pub. No.: US 2021/0245283 A1
(43) Pub. Date: Aug. 12, 2021

(54) METHOD OF JOINING HIGH ENTROPY ALLOY, APPARATUS FOR JOINING HIGH ENTROPY ALLOY, AND JOINED STRUCTURE OF HIGH ENTROPY ALLOY

(71) Applicants: SEOUL NATIONAL UNIVERSITY R&DB FOUNDATION, Seoul (KR); University of Ulsan Foundation For Industry Cooperation, Ulsan (KR); KOREA INSTITUTE OF SCIENCE AND TECHNOLOGY, Seoul (KR)

(72) Inventors: Heung Nam HAN, Seoul (KR); Min Gu JO, Seoul (KR); Sung Tae HONG, Seoul (KR); Nguyen Thi Anh Nguyet, Ulsan (KR); Jin-Yoo SUH, Seoul (KR)

(73) Assignees: SEOUL NATIONAL UNIVERSITY R&DB FOUNDATION, Seoul (KR); University of Ulsan Foundation For Industry Cooperation, Ulsan (KR); KOREA INSTITUTE OF SCIENCE AND TECHNOLOGY, Seoul (KR)

(21) Appl. No.: 17/167,171

(22) Filed: Feb. 4, 2021

(30) Foreign Application Priority Data
Feb. 7, 2020 (KR) 10-2020-0014910

(51) Int. Cl. B23K 9/09; C22C 30/00; B23K 20/22; B23K 9/095; B23K 20/02

(52) U.S. Cl. CPC B23K 9/09; C22C 30/00; B23K 2103/02; B23K 9/095; B23K 20/02; B23K 20/22

(57) ABSTRACT

A method of joining a high entropy alloy is provided. The method of joining a high entropy alloy includes the steps of: arranging specimens made of a high entropy alloy to be in contact with each other; and diffusion joining the specimens made of the high entropy alloy by simultaneously applying a compressive stress and a current to a joint of the specimens within a range in which the high entropy alloy does not melt.

### CROSS-REFERENCE TO RELATED APPLICATION(S)

This application claims the benefit under 35 USC § 119(a) of Korean Patent Application No. 10-2020-0014910, filed on Feb. 7, 2020, in the Korean Intellectual Property Office, the entire disclosure of which is incorporated herein by reference for all purposes.

### BACKGROUND

### 1. Field

The following description relates to a method of joining an alloy, an apparatus for joining an alloy, and a joined structure of an alloy, and more particularly, to a method of joining a high entropy alloy, an apparatus for joining a high entropy alloy, and a joined structure of a high entropy alloy.

### 2. Description of Related Art

Traditional alloys are composed of one or two principal elements, such as iron, nickel, aluminum, and the like, and additional alloying elements. High entropy alloys, which break through the traditional alloy design concepts, are composed of various principle elements (e.g., five or more principle elements), and unlike amorphous materials, they are crystalline and may have a single phase or a dual phase. The term “entropy” in high entropy alloys refers to entropy that constitutes Gibbs free energy in thermodynamics, and more specifically, may refer to configurational entropy. In other words, it refers to a value of entropy obtained when assuming that constituent elements of an alloy are randomly arranged. In the case of traditional alloys, entropy is relatively low, whereas high entropy alloys have high entropy due to many principal elements and high proportions thereof, and for this reason, they are referred to as “high entropy alloys.”

Generally known metal materials tend to increase in strength and decrease in elongation rate as temperature decreases. However, according to a report in the journal Science, the CrMnFeCoNi high entropy alloy consisting of Cr—Mn—Fe—Co—Ni in an equiatomic ratio, which was first presented as a high entropy alloy in 2004, exhibits excellent elongation even when temperature drops, unlike previously known metal materials, and accordingly has excellent toughness at low temperature.

Dendritic structures are formed when a metal material is cast. Conventional alloys contain one or two principal elements and a few percent of alloying elements, and hence micro-segregation between the dendrites and the inter-dendrites does not noticeably appear. However, in the case of high entropy alloys, the number of principal elements is varied and the ratio is relatively similar, so that micro-segregation commonly takes place after casting. Therefore, in order to achieve homogeneous composition distribution after casting, a high entropy alloy needs to undergo a process (e.g., homogenization treatment) to eliminate segregation by heat treatment for a long time at high temperatures.

Metal materials are used in wide field of applications, and a joining-welding process is inevitably required during the application. A common joining method is fusion welding in which materials to be bonded are directly melted or the materials are connected by melting filler material. When a high entropy alloy is joined by fusion welding, dendritic structure including micro-segregation appears at the joint. Accordingly, the materials/parts, obtained by fusion welding, may have weak physical properties in a specific region (e.g., joint).

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

An objective of the present invention is to provide a method and apparatus for joining a high entropy alloy capable of improving the properties of a joint of a high entropy alloy using a relatively simple method and apparatus.

According to one aspect of the present invention for achieving the above objectives, there is provided a method of joining a high entropy alloy.

The method of joining a high entropy alloy includes the steps of: arranging specimens made of a high entropy alloy to be in contact with each other; and diffusion joining the specimens made of the high entropy alloy by simultaneously applying a compressive stress and a current to a joint of the specimens within a range in which the high entropy alloy does not melt.

According to one embodiment of the present invention, the step of diffusion joining may include the step of applying a compressive stress and a plurality of pulse currents to the joint of the specimens at the same time.

According to one embodiment of the present invention, the step of diffusion joining may include the step of sequentially applying a first pulse current and a second pulse current while applying the compressive stress to the joint of the specimens, wherein a current value of the first pulse current is lower than a current value of the second pulse current.

According to one embodiment of the present invention, the step of diffusion joining may include the step of sequentially applying the first pulse current and the second pulse current to the joint of the specimens while applying a compressive stress, wherein the applying of the second pulse current may include the step of applying a plurality of sub-pulse currents to the joint of the specimens.

According to one embodiment of the present invention, an interval during which no current is applied may exist between the step of applying the first pulse current and the step of applying of the second pulse current, and between each step of applying each sub-pulse current.

According to one embodiment of the present invention, the step of applying the compressive stress to the specimens may include sequentially a first step of applying the compressive stress to the joint of the specimens while gradually increasing the compressive stress and a second step of applying a constant compressive stress to the joint of the specimens, wherein a time T1 at which the first step is terminated and the second step is started is any point in time during the step of applying the plurality of sub-pulse currents.

According to one embodiment of the present invention, the high entropy alloy may be CrMnFeCoNi containing chromium (Cr), manganese (Mn), iron (Fe), cobalt (Co), and nickel (Ni).

According to another aspect of the present invention for achieving the above objectives, there is provided an apparatus for joining a high entropy alloy.

The apparatus for joining a high entropy alloy includes a pair of electrodes configured to be connected to a power supply unit to apply a current to a joint of specimens made of a high entropy alloy; a stress applying unit configured to apply a compressive stress to the joint of the specimens through the pair of electrodes; and a control unit configured to adjust the compressive stress and the current so that the compressive stress and the current are simultaneously applied to the joint of the specimens within a range in which the high entropy alloy does not melt.

According to one embodiment of the present invention, the apparatus for joining a high entropy alloy may further include a heat measuring unit configured to measure a heat generated at the joint of the specimens made of the high entropy alloy so that the compressive stress and the current can be simultaneously applied to the joint of the specimens within a range in which the high entropy alloy does not melt.

According to one embodiment of the present invention, the control unit and the power supply unit may be configured to apply a plurality of pulse currents to the joint of the specimens.

According to another aspect of the present invention for achieving the above objectives, there is provided a joined structure of a high entropy alloy.

According to one embodiment of the present invention, the joined structure of a high entropy alloy may be a joined structure having a joint formed by diffusion joining a pair of high entropy alloys contacting each other, and the joint may not have a dendritic structure, and exhibits at least a partially recrystallized structure.

According to one embodiment of the present invention, the joint may have a recrystallized structure over the entire area thereof and may have the same structure as that of a base material portion adjacent to the joint.

Other features and aspects will be apparent from the following detailed description, the drawings, and the claims.

### BRIEF DESCRIPTION OF THE DRAWINGS

FIG. 1 is a diagram illustrating an apparatus for joining a high entropy alloy according to a comparative example of the present invention.

FIG. 2 is a diagram illustrating an apparatus for joining a high entropy alloy according to an embodiment of the present invention.

FIG. 3 is a graph illustrating an aspect of application of a compressive stress in a method of joining a high entropy alloy according to an embodiment of the present invention.

FIG. 4 is a graph illustrating an aspect of application of a current in a method of joining a high entropy alloy according to an embodiment of the present invention.

FIG. 5 is a graph showing the results of measuring a temperature of a joint of specimens over time in experimental examples of the present invention.

FIG. 6 shows side-view scanning electron microscope images showing the results of a chemical composition analysis of a joint of a specimen in the experimental example of the present invention.

FIG. 7 shows side-view scanning electron microscope images showing the results of a chemical composition analysis of a joint of a high entropy alloy to which a laser melting process is applied as another comparative example of the present invention.

FIG. 8 shows the results of an electron backscatter diffraction (EBSD) analysis on the center of a cross-section of the joint of the high entropy alloy according to various embodiments of the present invention.

FIG. 9 shows the results of an EBSD analysis on cross-sections of a joint and a base material portion of a high entropy alloy to which a laser welding process is applied as another comparative example of the present invention.

FIG. 10 is a graph showing the results of evaluating a joining strength of a specimen in the Experimental Examples of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

As discussed above, several problems arise when a high entropy alloy is joined by fusion welding, and the introduction of diffusion joining may be considered to join a high entropy alloy. First, friction stir welding (FSW), which is a method in which a very hard tool is rotated and inserted into a sample to forcibly stir the inside of a material, may be introduced, but there is a limitation in that it is required to develop a material of a tool that is stronger than the material to be joined and there are limitations with respect to complex joint shape. Next, diffusion joining which bonds high entropy alloys by promoting diffusion by temperature and pressure may be considered.

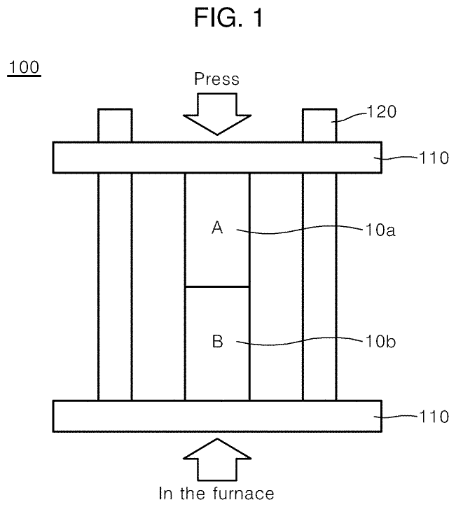

FIG. 1 is a diagram illustrating an apparatus 100 for joining a high entropy alloy according to a comparative example of the present invention.

Referring to FIG. 1, a pair of high entropy alloys 10a and 10b are brought into contact with each other and an external force (pressure) is applied to the pair of high entropy alloys 10a and 10b using pressing members 110 and 120. In addition, in order to apply heat to the pair of high entropy alloys 10a and 10b, the apparatus 100 is required to be inserted into a furnace.

That is, the method and apparatus for joining a high entropy alloy according to a comparative example of the present invention basically brings specimens of the pair of high entropy alloys 10a and 10b to be bonded into contact with each other and externally heats the specimens to promote atomic diffusion inside the specimens, thereby joining the alloys. Variables used in this process may include external pressure heating temperature, and time when contacting. However, since a grip-type structure is required to bring the pair of high entropy alloys 10a and 10b into contact with each other and the insertion into the furnace is needed to apply heat, there is a limitation in size. In addition, since structures other than the pair of high entropy alloys 10a and 10b intended to be brought into contact with each other also heated, efficiency is inferior. In conclusion, the method of diffusion joining of high entropy alloys by promoting diffusion by temperature and pressure is accompanied with a size limitation and is time and cost intensive.

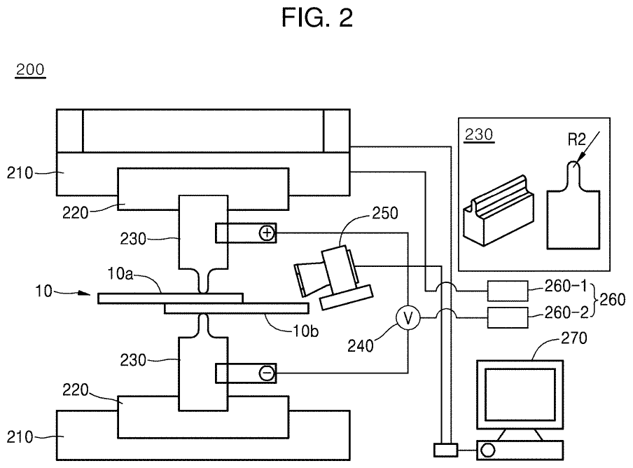

FIG. 2 is a diagram illustrating an apparatus for joining a high entropy alloy according to an embodiment of the present invention.

Referring to FIG. 2, the apparatus 200 for joining a high entropy alloy according to an embodiment of the present invention includes a pair of electrodes 230 configured to be connected to a power supply unit 240 to apply a current to a joint of specimens 10 (10a and 10b) made of a high entropy alloy; a stress applying unit 210 configured to apply a compressive stress to the joint of the specimens 10 through the pair of electrodes 230; and a control unit 260 configured to adjust the compressive stress and the current so that the compressive stress and the current are simultaneously applied to the joint of the specimens 10 within a range in which the high entropy alloy does not melt.

In one example, the control unit 260 may include a first control unit 260-1 for adjusting the compressive stress through the stress applying unit 210 and a second control unit 260-2 for adjusting the current. In this case, the first control unit 260-1 may be understood as at least a part of a computing device 270 which can issue a command to the stress applying unit 210 by using a program and digitize the conclusion derived accordingly. Further, the computing device 270 may digitize a result of a heat measuring unit 250, such as a thermal imaging camera.

In another example, the control unit 260 may be provided in a form in which the first control unit 260-1 for adjusting the compressive stress and the second control unit 260-2 for adjusting the current are integrated. In this case, a device for digitizing the result of the heat measuring unit 250, such as a thermal imaging camera, may be implemented by the computing device 270 that is separate from the control unit 260.

For example, a universal testing machine may be used as the stress applying unit 210. An electrical insulating unit 220 may be interposed between the stress applying unit 210 and the electrode 230.

Further, the heat measuring unit 250 may be further included to measure a heat generated at the joint of the specimens 10 made of the high entropy alloy so that the compressive stress and the current can be simultaneously applied to the joint of the specimens within a range in which the high entropy alloy does not melt. The control unit 260 and the power supply unit 260 may be configured to apply a plurality of pulse currents to the joint of the specimens 10.

That is, the apparatus 200 for joining a high entropy alloy according to an embodiment of the present invention is an apparatus that joins the specimens 10 with heat by using the conducting electrodes 230 as compression dies, and more specifically, places the specimens 10 to be welded together in the middle of equipment capable of producing displacement, and joins the specimens 10 with the heat generated by compressing, with the electrode dies, the specimens 10 from top and bottom and simultaneously applying a current to the specimens. In this case, heat generated at the joint may be indirectly measured from the outside through the heat measuring unit 250, such as a thermal imaging camera.

The high entropy alloy may be CrMnFeCoNi containing chromium (Cr), manganese (Mn), iron (Fe), cobalt (Co), and nickel (Ni). Specifically, the high entropy alloy may be a CrMnFeCoNi high entropy alloy in which chromium (Cr), manganese (Mn), iron (Fe), cobalt (Co), and nickel (Ni) elements exist at the equiatomic ratio, each in an amount of 20 at. %. However, the inventive concept is not necessarily limited to the type and composition of the high entropy alloy.

A method of joining a high entropy alloy using the above-described apparatus for joining a high entropy alloy includes the steps of: arranging specimens made of a high entropy alloy to be in contact with each other (S10); and diffusion joining the specimens made of the high entropy alloy by simultaneously applying a compressive stress and a current to a joint of the specimens within a range in which the high entropy alloy does not melt (S20).

Hereinafter, a method of applying a compressive stress and a current to a joint of a high entropy alloy will be described.

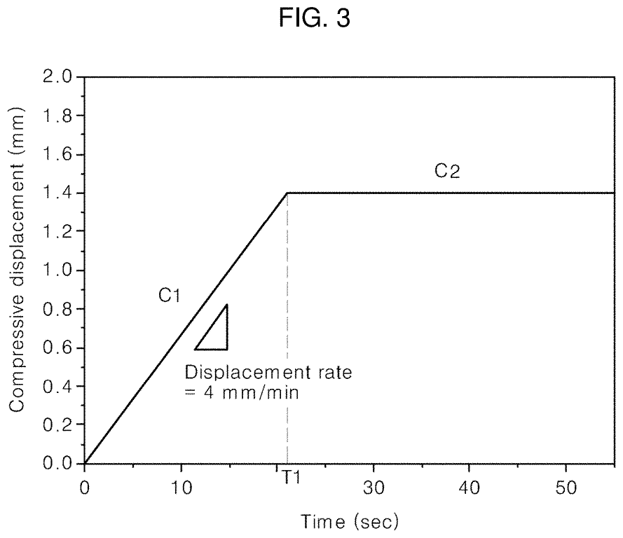

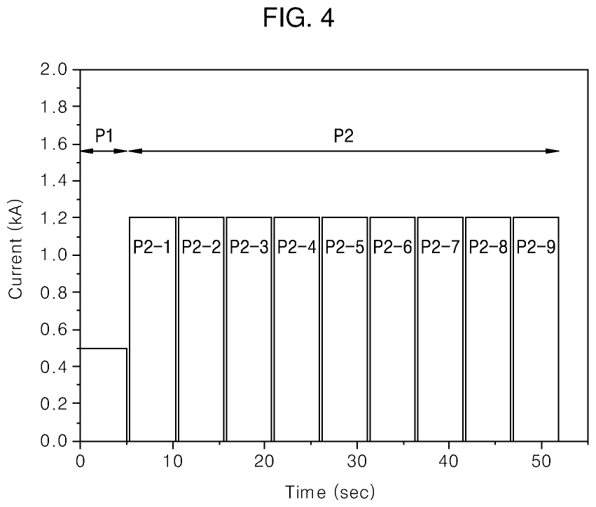

FIG. 3 is a graph illustrating an aspect of application of a compressive stress in a method of joining a high entropy alloy according to an embodiment of the present invention, and FIG. 4 is a graph illustrating an aspect of application of a current in a method of joining a high entropy alloy according to an embodiment of the present invention.

Referring to FIGS. 3 and 4, in the method of joining a high entropy alloy according to an embodiment of the present invention, the diffusion joining (S20) may include the step of applying a compressive stress and a plurality of pulse currents to the joint of the specimens 10 at the same time.

In one example, the diffusion joining (S20) may include the step of sequentially applying a first pulse current P1 and a second pulse current P2 while applying the compressive stress to the joint of the specimens 10, wherein a current value of the first pulse current and a current value of the second pulse current P2 may be adjusted within a range in which the high entropy alloy does not melt. For example, the current value of the first pulse current P1 may be lower than the current value of the second pulse current P2.

When a current is applied to the specimen 10, heat is generated in the contact area between the electrode 230 and the specimen 10. When a current having a single current value is continuously applied to the specimen, the temperature rises linearly, which may cause the high entropy alloy to melt. However, as described above, when the current is applied in the form of a pulse, it is possible to implement the aspect of maintaining the temperature after the temperature rises. By implementing the aspects of determining the first pulse duration and the second pulse duration, performing preheating during the first pulse duration, and maintaining the raised temperature during the second pulse duration, it is possible to provide the temperature and time required to join a high entropy alloy.

Meanwhile, the diffusion joining (S20) may include the step of sequentially applying the first pulse current P1 and the second pulse current P2 to the joint of the specimens 10 while applying a compressive stress, wherein the applying of the second pulse current P2 may include the step of applying a plurality of sub-pulse currents P2-1, P2-2, P2-3, P2-4, P2-5, P2-6, P2-7, P2-8, and P2-9 to the joint of the specimens 10. The number of times of applying the sub-pulse currents may be appropriately adjusted to control a temperature profile at the joint of the high entropy alloy.

Further, in the method of joining a high entropy alloy, an interval during which no current is applied may exist between the application of the first pulse current P1 and the application of the second pulse current P2. In addition, in the step of applying the plurality of sub-pulse currents P2-1, P2-2, P2-3, P2-4, P2-5, P2-6, P2-7, P2-8, and P2-9, an interval during which no current is applied may exist between each step of applying each sub-pulse current.

In the method of joining a high entropy alloy according to an embodiment of the present invention, the step of applying the compressive stress to the specimens 10 may sequentially include a first step (C1) of applying the compressive stress to the joint of the specimens while gradually increasing the compressive stress and a second step (C2) of applying a constant compressive stress to the joint of the specimens, wherein a time T1 at which the first step (C1) is terminated and the second step (C1) is started is any point in time during the step of applying the plurality of sub-pulse currents P2-1, P2-2, P2-3, P2-4, P2-5, P2-6, P2-7, P2-8, and P2-9. In the first step (C1), the compressive stress may be applied such that a displacement rate has a constant positive value (e.g., 4 mm/min), and in the second step (C2), the compressive stress may be applied such that a compressive stress value is constant.

In the above-described method of joining a high entropy alloy, joining is performed using heat generated by applying a compressive force to the electrodes and simultaneously applying a current to the electrodes. The heat generated by the application of the current promotes the diffusion inside of the metal by energizing a circuit, and a material is joined by the diffusion without dissolving the material. At this time, the current is not continuously applied under one condition, but the first pulse duration during which instantaneous preheating is performed and the second pulse duration during which a high temperature is maintained by applying a current nine times after several milliseconds from the first pulse duration are provided. Joining is performed under the condition where a high temperature is maintained for a short period of time by applying a pulse and simultaneously measuring a temperature using a thermal imagining camera.

According to the above-described apparatus and method for joining a high entropy alloy, there is no need to develop a material stronger than the high entropy alloy to be joined, there is no limitation with respect to the complex joint shape, there is no size limitation of the structure of an object to be joined, and it is possible to reduce time and cost. In other words, when fusion welding is used to join a high entropy alloy, chemical, microstructural heterogeneity occurs in the weld. If friction stir welding is applied to avoid such heterogeneity, it is required to develop a rotating tool for use according to the strength of the material. However, the method of joining a high entropy alloy according to an embodiment of the present invention enables joining by changing the condition for a current to be applied, irrespective of the strength of a material. Yet, it is necessary to know the melting point of a material in advance, and the current and voltage conditions to be applied to the first pulse and the second pulse may be determined by taking into account the resistance of each material. Therefore, any material can be used, irrespective of its strength, and hence the use of the method is not limited, and according to the current and voltage conditions applied, the method may be applicable to the entire range of metal that conducts electrical current.

A joined structure of a high entropy alloy may be implemented using the above-described method and apparatus for joining a high entropy alloy.

The joined structure of a high entropy alloy is a joined structure having a joint formed by diffusion joining a pair of high entropy alloys contacting each other, and the joint does not have a dendritic structure, and exhibits at least a partially recrystallized structure. Further, in the joined structure of a high entropy alloy, the joint may have a recrystallized structure over the entire area thereof and may have the same structure as that of a base material portion adjacent to the joint.

### Experimental Examples

Hereinafter, preferred experimental examples are presented to assist in understanding the present invention. However, the following experimental examples are intended only to aid understanding of the present invention, and the present invention is not limited by the following experimental examples.

Table 1 shows conditions in which a compressive stress and a current are simultaneously applied to a joint of high entropy alloy specimens in a method of joining a high entropy alloy according to experimental examples of the present invention.

TABLE 1

| | \textcircled{1} | \textcircled{2} | \textcircled{3} | \textcircled{4} | \textcircled{5} | \textcircled{6} | \textcircled{7} |
|---|---|---|---|---|---|---|---|
| Experimental | 0.2 kA | 2 sec | 0.5 kA | 3sec | 0.5 sec | 9 | 33.5 sec |
| Example 1 | | | | | | | |
| Experimental | 0.5 kA | 5 sec | 1.0 kA | 5 sec | 0.2 sec | 9 | 51.8 sec |
| Example 2 | | | | | | | |
| Experimental | 0.5 kA | 5 sec | 1.2 kA | 5 sec | 0.2 sec | 9 | 51.8 sec |
| Example 3 | | | | | | | |
| Experimental | 0.5 kA | 5 sec | 1.3 kA | 5 sec | 0.2 sec | 9 | 51.8 sec |
| Example 4 | | | | | | | |

Conditions for applying the compressive stress in Experimental Examples 1 to 4 of the present invention are pre-load: 200N, displacement rate: 4 mm/min, and maximum displacement: 1.4 mm.

Also referring to FIG. 4, items \textcircled{1} to \textcircled{2} in Table 1 relate to the first pulse current P1, and specifically, item \textcircled{1} represents a current value of the first pulse current P1, and item \textcircled{2} represents the duration of the first pulse current P1. Items \textcircled{3} to \textcircled{6} relate to the second pulse current (P2), and specifically, item \textcircled{3} represents a current value of each sub-pulse current P2-1, P2-2, P2-3, P2-4, P2-5, P2-6, P2-7, P2-8, and P2-9, item \textcircled{4} represents a duration of each sub-pulse current P2-1, P2-2, P2-3, P2-4, P2-5, P2-6, P2-7, P2-8, and P2-9, item \textcircled{5} represents an the interval between the first pulse current P1 and the second pulse current P2 or an interval between each sub-pulse current P2-1, P2-2, P2-3, P2-4, P2-5, P2-6, P2-7, P2-8, and P2-9, and item \textcircled{6} represents the number of times the sub-pulse current is applied. The interval corresponds to an interval during which no current is applied to the joint of high entropy alloy specimens. Referring to Table 1, the time required in Experimental Example 1 is a total of 33.5 seconds, and the time required in each of Experimental Examples 2 to 4 is a total of 51.8 seconds.

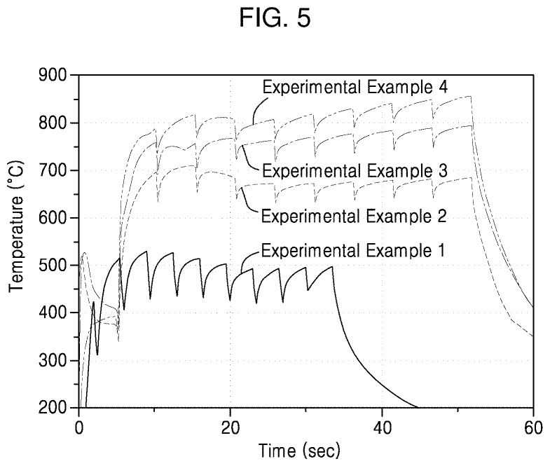

FIG. 5 is a graph showing the results of measuring a temperature of a joint of specimens over time in Experimental Examples of the present invention.

Referring to FIG. 5, it can be seen that the joint of the high entropy alloy maintains a relatively low temperature without exceeding the melting point of the high entropy alloy when an external force (pressure) and a current for diffusion joining are applied under the conditions of Experimental Example 1 (0.2 kA 2 sec+0.5 kA 3 sec*9 cycle), Experimental Example 2 (0.5 kA 5 sec+1.0 kA 5 sec*9 cycle), Experimental Example 3 (0.5 kA 5 sec+1.2 kA 5 sec*9 cycle), and Experimental Example 4 (0.5 kA 5 sec+1.3 kA 5 sec*9 cycle) shown in Table 1.

That is, in the experimental examples of the present invention, a pre-load is initially applied so that the specimens to be joined are pressed by the electrodes, and thereafter a current is applied and at the same time compression is applied. At this time, the average temperature reached according to the current conditions is about 500 degrees (Experimental Example 1), 650 degrees (Experimental Example 2), 750 degrees (Experimental Example 3), and 850 degrees (Experimental Example 4). As described above, a current is not continuously applied under a single current condition that causes continual rise in temperature, but the temperature is maintained by applying a current in a pulsed manner.

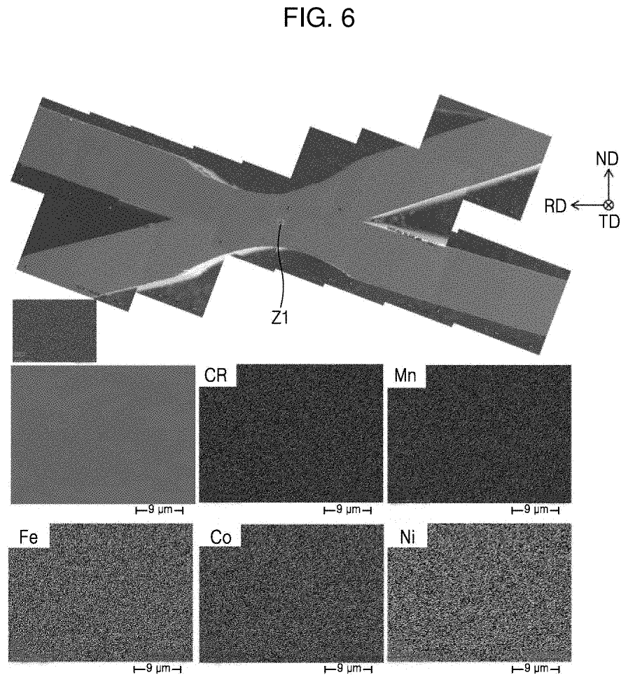

FIG. 6 shows side-view scanning electron microscope images showing the results of a chemical composition analysis of the joint of the specimen in Experimental Example 1 of the present invention using an energy dispersive spectrometer (EDS). The composition distribution shown in the lower portion of the figure is the composition distribution of area Z1 shown in the upper portion.

Referring to FIG. 6, it can be seen that a chemically uniform distribution appears in the joint region of the high entropy alloy under the condition of reaching about 500 degrees, which indicates that diffusion joining is satisfactory. The satisfactory diffusion joining is observed not only at the middle of the joint but also at the edge of the joint.

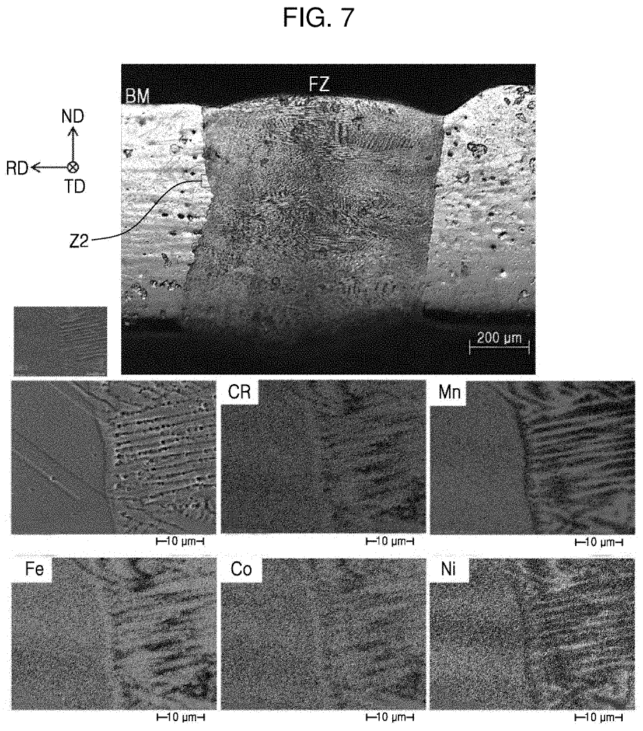

FIG. 7 shows side-view scanning electron microscope images showing the results of a chemical composition analysis of a joint of a high entropy alloy to which a laser melting process is applied as another comparative example of the present invention. The composition distribution shown in the lower portion of the figure is the composition distribution of area Z2 shown in the upper portion.

Referring to FIG. 7, it can be seen that micro-segregation occurs due to fusion welding. In the case of high entropy alloys, the number of principle elements is varied and the ratio of each element is relatively similar, so it is common for micro-segregation to appear after fusion welding. Therefore, in order to achieve homogeneous composition distribution after fusion welding, a high entropy alloy needs to undergo a process (e.g., homogenization treatment) to eliminate segregation by heat treatment for a long time at high temperatures.

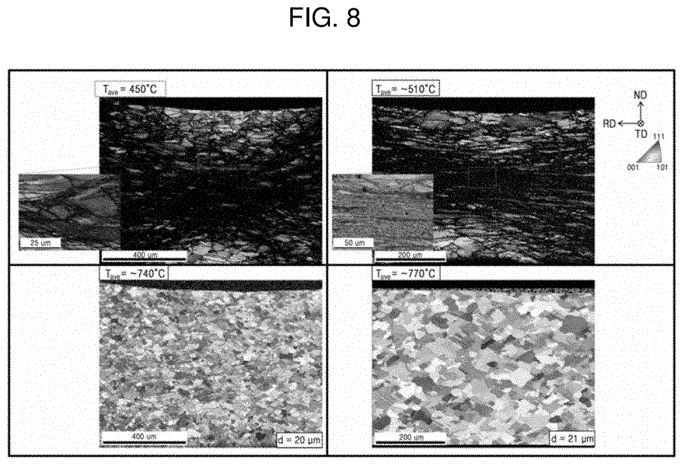

FIG. 8 is an electron backscatter diffraction (EBSD) IPF map showing the results of an EBSD analysis on the center of a cross-section of the joint of the high entropy alloy according to various embodiments of the present invention. (a) of FIG. 8 is a case where the average temperature at the center of the cross-section of the joint is about 450° C., (b) of FIG. 8 is a case where the average temperature at the center of the cross-section of the joint is about 510° C., (c) of FIG. 8 is a case where the average temperature at the center of the cross-section of the joint is about 740° C., and (d) of FIG. 8 is a case where the average temperature at the center of the cross-section of the joint is about 770° C. FIG. 8 (b) shows the EDS chemical composition distribution according to Experimental Example 1 (0.2 kA 2 sec+0.5 kA 3 sec*9 cycle), and FIG. 8 (c) shows the EDS chemical composition distribution according to Experimental Example 3 (0.5 kA 5 sec+1.2 kA 5 sec*9 cycle) of the present invention.

Referring to FIG. 8, it can be confirmed that diffusion joining is successfully implemented even under relatively low heating conditions and in a short time, and from the EBSD analysis, it can be confirmed that partial recrystallization has occurred at the joint. On the other hand, it can be confirmed that complete recrystallization and grain growth have occurred throughout the joint when a current was applied under high heating conditions. This means that by adjusting conditions of complete diffusion joining and a current, the joint and a base material portion can be joined in a completely identical state. That is, as a result of observing the microstructure through EBSD, it was found that partial recrystallization occurred in the middle region with the most deformation in the joint under the condition that the reached temperature was relatively low, and it was confirmed that, under the condition that the reached temperature was relatively high, the joint has a microstructure almost similar to that of the base material as recrystallization and grain growth occurred in the entire area of the joint.

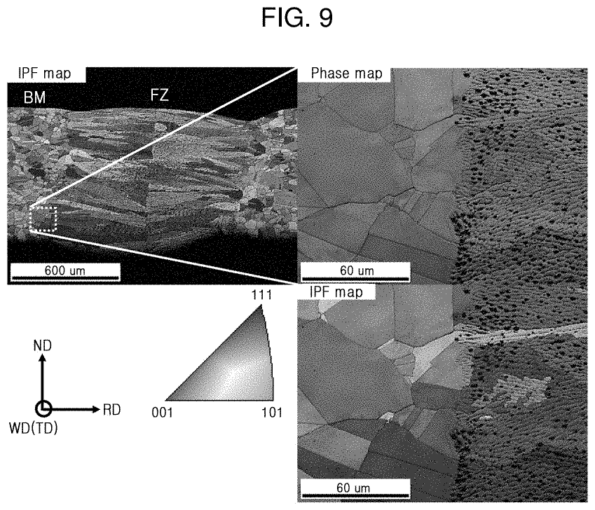

FIG. 9 shows the results of an EBSD analysis on cross-sections of a joint and a base material portion of a high entropy alloy to which a laser welding process is applied as another comparative example of the present invention.

Referring to FIG. 9, it can be seen that the fusion zone FZ of the joint of a high entropy alloy to which a laser welding process is applied has coarse crystal grains and a plurality of dendritic structures. The dendritic structure may include a structure in which the high entropy alloy is melted and then solidified. The dendrites are formed by growing from the boundary between a molten portion and a base material portion to the central portion of the joint. When the alloy is melted and solidified again during fusion welding, the unmelted solid portion is used as a seed to grow into a longer structure.

Referring to FIG. 8 in conjunction with 9, a joined structure of a high entropy alloy according to another aspect of the present invention is a joined structure having a joint formed by diffusion joining a pair of high entropy alloys contacting each other, wherein the joint does not have a dendritic structure and exhibits at least a partially recrystallized structure, and the recrystallized structure has the same structure as that of a base material portion adjacent to the joint. Further, it can be understood that, in the joined structure of a high entropy alloy, the joint may have a recrystallized structure over the entire area thereof and may have the same structure as that of the base material portion adjacent to the joint.

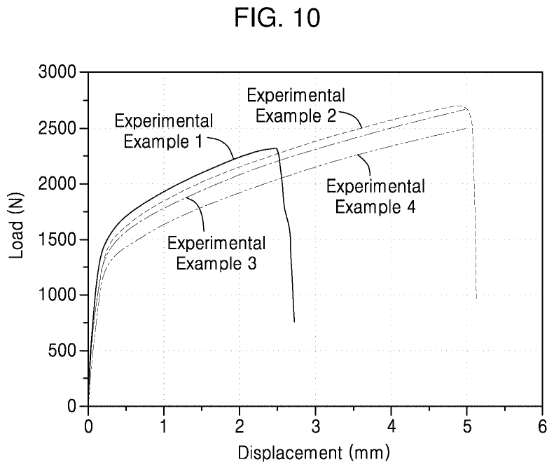

FIG. 10 is a graph showing the results of evaluating a joining strength of a specimen in the experimental examples of the present invention.

Referring to FIG. 10, a tensile-shear test was conducted to evaluate the joining strength of the specimen in the experimental example of the present invention. It can be confirmed that the structure with significant deformed structure and very fine partial recrystallization exhibited the highest flow, but the shortest displacement, and after complete recrystallization, it exhibited almost similar displacement, but as in the flow, it exhibited softer according to the grain size.

That is, it can be seen that, under the condition that the reached temperature was low, a relatively strong load-displacement curve was exhibited due to the deformed structure and the fine partial recrystallized structure, but fracture appeared early due to the heterogeneous microstructure. When the current condition is changed to reach a temperature above a certain value, recrystallization occurs throughout the entire area and grain growth additionally occurs. As the temperature reached increases, the grain size increases due to the grain growth and accordingly, the curve is lowered.

According to the embodiment of the present invention, it is possible to implement a method and apparatus for joining a high entropy alloy which can improve properties of a joint of a high entropy alloy by using a relatively simple method and apparatus. Further, it is possible to implement a joined structure of a high entropy alloy in which a joint and a base material portion have the identical structure. It should be understood that the scope of the present invention is not limited by these effects.

Although the invention has been described and illustrated with reference to specific illustrative embodiments thereof, it is not intended that the invention be limited to those illustrative embodiments. Those skilled in the art will recognize that variations and modifications can be made without departing from the spirit of the invention. It is therefore intended to include within the invention all such variations and modifications that fall within the scope of the appended claims and equivalents thereof.

What is claimed is:

1. A method of joining a high entropy alloy comprising the steps of:
arranging specimens made of a high entropy alloy to be in contact with each other; and
diffusion joining the specimens made of the high entropy alloy by simultaneously applying a compressive stress and a current to a joint of the specimens within a range in which the high entropy alloy does not melt.

2. The method of claim 1, wherein the step of diffusion joining comprises the step of applying a compressive stress and a plurality of pulse currents to the joint of the specimens at the same time.

3. The method of claim 1, wherein the step of diffusion joining comprises the step of sequentially applying a first pulse current and a second pulse current while applying the compressive stress to the joint of the specimens,
wherein a current value of the first pulse current is lower than a current value of the second pulse current.

4. The method of claim 1, wherein the step of diffusion joining comprises the step of sequentially applying the first pulse current and the second pulse current to the joint of the specimens while applying a compressive stress,
wherein the step of applying the second pulse current may include the step of applying a plurality of sub-pulse currents to the joint of the specimens.

5. The method of claim 4, wherein an interval during which no current is applied exists between the step of applying the first pulse current and the step of applying of the second pulse current, and between each step of applying each sub-pulse current.

6. The method of claim 4, wherein the step of applying the compressive stress to the specimens comprises sequentially a first step of applying the compressive stress to the joint of the specimens while gradually increasing the compressive stress and a second step of applying a constant compressive stress to the joint of the specimens,
wherein a time T1 at which the first step is terminated and the second step is started is any point in time during the step of applying the plurality of sub-pulse currents.

7. The method of claim 1, wherein the high entropy alloy is CrMnFeCoNi containing chromium (Cr), manganese (Mn), iron (Fe), cobalt (Co), and nickel (Ni).

8. An apparatus for joining a high entropy alloy, comprising:
a pair of electrodes configured to be connected to a power supply unit to apply a current to a joint of specimens made of a high entropy alloy;
a stress applying unit configured to apply a compressive stress to the joint of the specimens through the pair of electrodes; and
a control unit configured to adjust the compressive stress and the current so that the compressive stress and the current are simultaneously applied to the joint of the specimens within a range in which the high entropy alloy does not melt.

9. The apparatus of claim 8, further comprising a heat measuring unit configured to measure a heat generated at the joint of the specimens made of the high entropy alloy so that the compressive stress and the current can be simultaneously applied to the joint of the specimens within a range in which the high entropy alloy does not melt.

10. The apparatus of claim 8, wherein the control unit and the power supply unit are each configured to apply a plurality of pulse currents to the joint of the specimens.

11. A joined structure of a high entropy alloy comprising a joined structure having a joint formed by diffusion joining a pair of high entropy alloys contacting each other,
wherein the joint does not have a dendritic structure and exhibits at least a partially recrystallized structure, and the recrystallized structure has the same structure as that of a base material portion adjacent to the joint.

12. The joined structure of a high entropy alloy of claim 11, wherein the joint has a recrystallized structure over the entire area thereof and has the same structure as that of a base material portion adjacent to the joint.
